(19) United States
(12) Patent Application Publication
(10) Pub. No.: US 2023/0084465 A1
(43) Pub. Date: Mar. 16, 2023

(54) COMMUNICATION LOAD BALANCING VIA META MULTI-OBJECTIVE REINFORCEMENT LEARNING

(71) Applicant: SAMSUNG ELECTRONICS CO., LTD., Suwon-si (KR)

(72) Inventors: Di Wu, Saint-Laurent (CA); Amal Feriani, Montreal (CA); Yi Tian Xu, Montreal (CA); Seowoo Jang, Seoul (KR); Michael Jenkin, Toronto (CA); Xue Liu, Montreal (CA); Gregory Lewis Dudek, Westmount (CA); Jimmy Li, Montreal (CA)

(73) Assignee: SAMSUNG ELECTRONICS CO., LTD., Suwon-si (KR)

(21) Appl. No.: 17/903,646

(22) Filed: Sep. 6, 2022

Related U.S. Application Data
(60) Provisional application No. 63/242,417, filed on Sep. 9, 2021.

(51) Int. Cl. H04L 41/16; H04W 24/10; G06N 5/02; G06K 9/62

(52) U.S. Cl. CPC H04L 41/16; H04W 24/10; G06N 5/022; G06K 9/6265

(57) ABSTRACT

Parameters for load balancing in a cellular communication system are determined. The cellular communication system performance is measured by key performance indicators (KPIs). A policy (artificial intelligence model) is obtained to optimize the cellular communication system performance with respect to the KPIs. The policy for determining parameters used for load balancing the cellular communication system is obtained using meta multi-objective reinforcement learning (meta MORL). A distilled policy may be obtained to initialize the meta MORL determination. Various loss functions may be used to obtain the distilled policy.

### CROSS REFERENCE TO RELATED APPLICATION

This application claims benefit of priority of U.S. Provisional Application No. 63/242,417 filed Sep. 9, 2021, the contents of which are hereby incorporated by reference.

### FIELD

The present disclosure is related to obtaining a policy, for load balancing a communication system, with a learning technique using multi-objective reinforcement learning and meta-learning.

### BACKGROUND

The fast-increasing traffic demand in a cellular communication system may cause uneven distribution of load across the network in the cellular communication system. Load balancing allocates load according to available resources such as bandwidth and base stations. Allocating includes redistributing the traffic load between different available resources. Load balancing requires automatic adjustment of several parameters to improve key performance indicators (KPIs). Maximizing one KPI such as minimum throughput (Tₘᵢₙ) over all base stations may lead to poor performance in another KPI such as standard deviation of throughput (T_{std}).

Alternative solutions may consider multiple KPIs simultaneously, but not provide sufficient performance for certain KPIs, for example the alternative solutions do not result in sufficient performance. An example of an alternative solution is the radial algorithm (RA) of S. Parisi, M. Pirotta, N. Smacchia, L. Bascetta and M. Restelli, “Policy gradient approaches for multi-objective sequential decision making: A comparison,” IEEE Symposium on Adaptive Dynamic Programming and Reinforcement Learning (ADPRL), 2014, pp. 1-8.

In one example, the present application relates to the support of cellular communications particularly with respect to supporting traffic volume efficiently with an effective artificial intelligence model (AI model). Supporting includes regulating and handling cellular communications. In embodiments, an AI model may also be referred to as a policy. An example of cellular communications is 5G. The application also relates to problems of energy saving in a telecommunications network.

In embodiments, artificial intelligence model may referred to as a task. An AI model, also referred to as a learned reinforcement learning model, may also be referred to as a policy, in embodiments. Further, in embodiments, in reinforcement learning, experiences or histories of a policy performing in an environment may be referred to as trajectories.

### SUMMARY

Embodiments provided herein apply multi-objective reinforcement learning (MORL) to simultaneously increase Tₘᵢₙ while reducing T_{std}. In some embodiments, meta-MORL load balancing (also referred to as MeMo LB) is used to efficiently learn from available data. In some embodiments, a distilled policy from tasks with a variety of KPI goals is used to initialize the MeMo LB solution.

Embodiments provided herein outperform comparative approaches such as the radial algorithm cited above. Thus KPIs for a cellular communication system are improved and bandwidth and base stations are more effectively used in providing cellular communications.

In the discussion below, there may be more than two preference vectors.

Provided herein is a method of obtaining a key performance indicator (KPI) fast-adaptive artificial intelligence (AI) model, the method including: receiving first KPI preference setting information; obtaining a first AI model based on the first KPI preference setting information; receiving second KPI preference setting information; obtaining a second AI model based on the second KPI preference setting information; obtaining a distilled AI model by knowledge distillation based on the first AI model and the second AI model; and obtaining the KPI fast-adaptive AI model by meta learning based on the distilled AI model, the first KPI preference setting information and the second KPI preference setting information. The preferences for policy distillation and meta-learning are not necessarily the same.

In some embodiments, the method includes applying the KPI fast-adaptive AI model to perform load balancing in a cellular communications system.

In some embodiments, the method includes initializing the KPI fast-adaptive AI model with the distilled policy.

In some embodiments, the method includes performing, using the KPI fast-adaptive AI model, task adaptation for a first task associated with a first preference vector and a second task associated with a second preference vector to obtain a plurality of first task parameters and a plurality of second task parameters, wherein the first preference vector indicates a first weighting over a plurality of KPIs and the second preference vector indicates a second weighting over the plurality of KPIs; collecting one or more first validation trajectories and one or more second validation trajectories, wherein the first task is associated with a first task policy and with first task parameters, and the second task is associated with a second task policy and with second task parameters; and updating a plurality of meta parameters of the KPI fast-adaptive AI model using the one or more first validation trajectories and the one or more second validation trajectories.

In some embodiments, the obtaining the distilled AI model includes using a distillation loss function.

In some embodiments, the method includes obtaining the distilled AI model by knowledge distillation based on the first AI model and the second AI model includes: training the first AI model, wherein the first AI model corresponds to a first teacher; training the second AI model, wherein the second AI model corresponds to a second teacher; collecting a plurality of trajectories using the first teacher and the second teacher; and training the distilled policy to match state-dependent action probability distributions of the first teacher and the second teacher using the distillation loss function.

In some embodiments, the distillation loss function expresses a Kullback-Leibler (KL) divergence loss.

In some embodiments, the distillation loss function expresses a negative log likelihood loss.

In some embodiments, the distillation loss function expresses a mean-squared error loss.

In some embodiments, the method includes fine tuning the KPI fast-adaptive AI model to approximate a Pareto front.

In some embodiments, obtaining the KPI fast-adaptive AI model by meta learning includes: the performing the task adaptation includes: sampling one or more first training trajectories using the KPI fast-adaptive AI model; updating the plurality of first task parameters of the first task policy based on the one or more first training trajectories; sampling one or more second training trajectories using the KPI fast-adaptive AI model; and updating the plurality of second task parameters of the second task policy based on one or more second training trajectories; and the collecting includes: obtaining the one or more first validation trajectories using the KPI fast-adaptive AI model; and obtaining the one or more second validation trajectories using the KPI fast-adaptive AI model.

Also provided herein is a server for obtaining a key performance indicator (KPI) fast-adaptive artificial intelligence (AI) model, the server including: one or more processors; and one or more memories, the one or more memories storing a program, wherein execution of the program by the one or more processors is configured to cause the server to at least: receive first KPI preference setting information; obtain a first AI model based on the first KPI preference setting information; receive second KPI preference setting information; obtain a second AI model based on the second KPI preference setting information; obtain a distilled AI model by knowledge distillation based on the first AI model and the second AI model; and obtain the KPI fast-adaptive AI model by meta learning based on the distilled AI model, the first KPI preference setting information and the second KPI preference setting information.

Also provided herein is a non-transitory computer readable medium configured to store a program for obtaining a key performance indicator (KPI) fast-adaptive artificial intelligence (AI) model, wherein execution of the program by one or more processors of a server is configured to cause the server to at least: receive first KPI preference setting information; obtain a first AI model based on the first KPI preference setting information; receive second KPI preference setting information; obtain a second AI model based on the second KPI preference setting information; obtain a distilled AI model by knowledge distillation based on the first AI model and the second AI model; and obtain the KPI fast-adaptive AI model by meta learning based on the distilled AI model, the first KPI preference setting information and the second KPI preference setting information.

Provided herein is a method of multi-objective reinforcement learning load balancing, the method including: initializing a meta policy; performing, using the meta policy, task adaptation for a first task associated with a first preference vector and a second task associated with a second preference vector to obtain a plurality of first task parameters and a plurality of second task parameters. The first preference vector indicates a first weighting over a plurality of key performance indicators and the second preference vector indicates a second weighting over the plurality of KPIs. The method also includes collecting one or more first validation trajectories and one or more second validation trajectories, wherein the first task is associated with a first task policy and with first task parameters, and the second task is associated with a second task policy and with second task parameters; updating a plurality of meta parameters of the meta policy using the one or more first validation trajectories and the one or more second validation trajectories; and applying the meta policy to perform load balancing in a cellular communications system.

Also provided herein is a server for multi-objective reinforcement learning load balancing, the server including: one or more processors; and one or more memories, the one or more memories storing a program, wherein execution of the program by the one or more processors is configured to cause the server to at least: initialize a meta policy; perform, using the meta policy, task adaptation for a first task associated with a first preference vector and a second task associated with a second preference vector to obtain a plurality of first task parameters and a plurality of second task parameters. The first preference vector indicates a first weighting over a plurality of key performance indicators and the second preference vector indicates a second weighting over the plurality of KPIs. The program is further configured to cause the server to collect one or more first validation trajectories and one or more second validation trajectories, wherein the first task is associated with a first task policy and with first task parameters, and the second task is associated with a second task policy and with second task parameters; update a plurality of meta parameters of the meta policy using the one or more first validation trajectories and the one or more second validation trajectories; and apply the meta policy to perform load balancing in a cellular communications system.

Also provided herein is a non-transitory computer readable medium configured to store a program for multi-objective reinforcement learning load balancing, wherein execution of the program by one or more processors of a server is configured to cause the server to at least: initialize a meta policy; perform, using the meta policy, task adaptation for a first task associated with a first preference vector and a second task associated with a second preference vector to obtain a plurality of first task parameters and a plurality of second task parameters. The first preference vector indicates a first weighting over a plurality of key performance indicators and the second preference vector indicates a second weighting over the plurality of KPIs. The stored program is further configured to cause the server to collect one or more first validation trajectories and one or more second validation trajectories, wherein the first task is associated with a first task policy and with first task parameters, and the second task is associated with a second task policy and with second task parameters; update a plurality of meta parameters of the meta policy using the one or more first validation trajectories and the one or more second validation trajectories; and apply the meta policy to perform load balancing in a cellular communications system.

### BRIEF DESCRIPTION OF THE DRAWINGS

The text and figures are provided solely as examples to aid the reader in understanding the invention. They are not intended and are not to be construed as limiting the scope of this invention in any manner. Although certain embodiments and examples have been provided, it will be apparent to those skilled in the art based on the disclosures herein that changes in the embodiments and examples shown may be made without departing from the scope of embodiments provided herein.

FIG. 1A illustrates knowledge distillation and meta training related to the cellular communications system, according to some embodiments.

FIG. 1B illustrates example logic for initializing a meta policy, updating the meta policy and applying the meta policy, according to some embodiments.

FIG. 1C illustrates example logic for additional details of MORL applied to load balancing, according to some embodiments.

FIG. 2 illustrates an example system architecture for MORL applied to load balancing, according to some embodiments.

FIG. 3 illustrates example logic at a parameter server and at a base station for MORL applied to load balancing, according to some embodiments.

FIG. 4 illustrates example logic for obtaining a distilled policy used in MORL applied to load balancing, according to some embodiments.

FIG. 5 illustrates example logic for MORL in general (distilled policy possibly not used), according to some embodiments.

FIG. 6 illustrates example logic for forming a policy set PB and then a distilled policy in order to initialize MORL, according to some embodiments.

FIG. 7 illustrates example logic for real-field (deployed in working system) inference of parameters for load balancing in a cellular communication system, according to some embodiments.

FIG. 8 illustrates messages between a base station and a parameter server for MORL applied to load balancing, according to some embodiments.

FIG. 9 illustrates exemplary hardware for implementation of computing devices such as parameter server 2-8, the base station 2-12, according to some embodiments.

### DETAILED DESCRIPTION

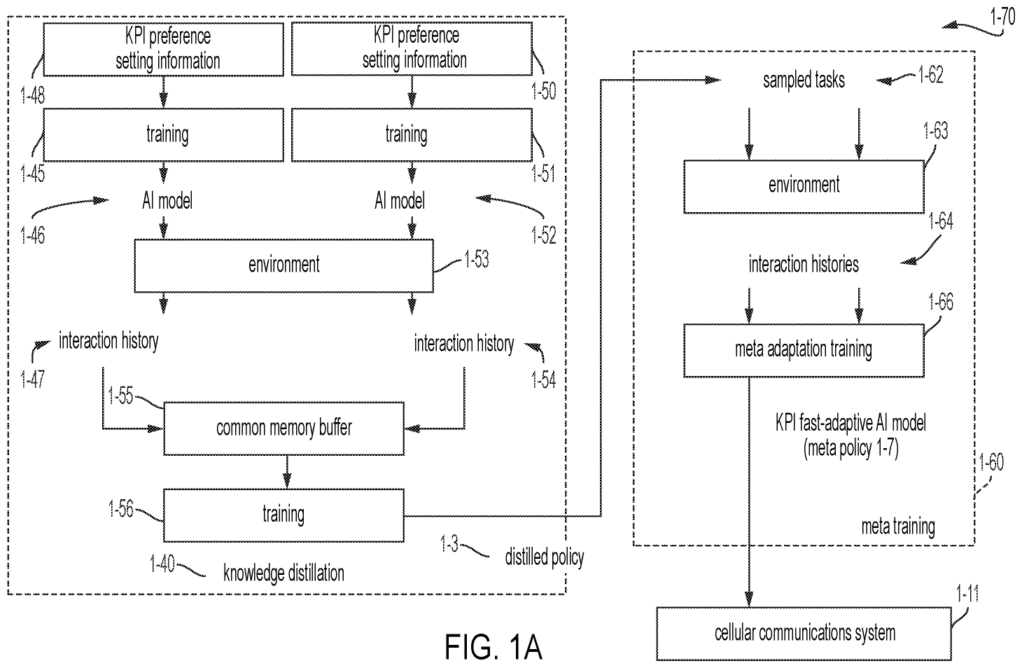

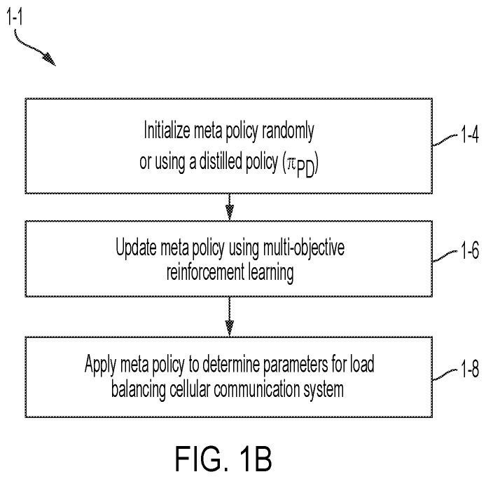

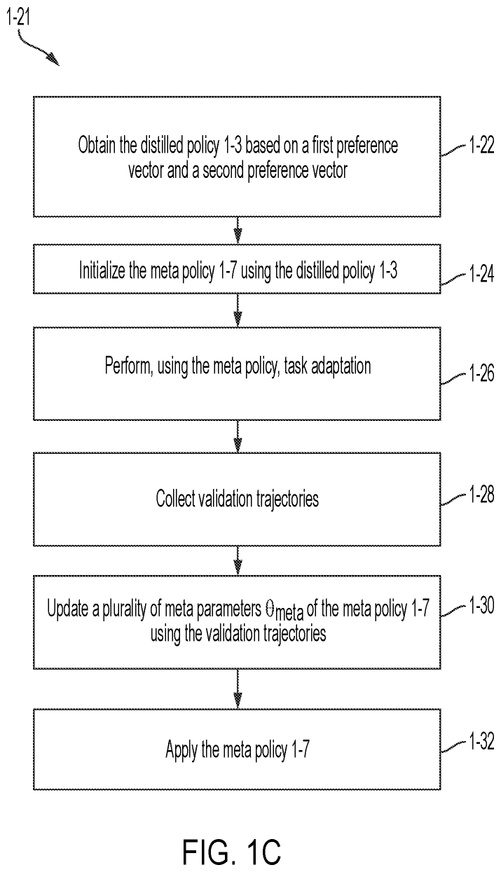

FIG. 1A is an overview figure and introduces concepts and terms.

FIG. 1A illustrates a cooperative arrangement 1-70 of beginning meta training 1-60 using knowledge distillation 1-40 so that performance of the cellular communication system 1-11 can be improved. Knowledge distillation 1-40 is shown on the left of FIG. 1A, meta training 1-60 is on the right, and the cellular communications system 1-11 is indicated in the lower right.

Knowledge distillation 1-40 combines knowledge from different AI models into a single distilled AI model. In FIG. 1A the single distilled AI model is referred to as distilled policy 1-3. The knowledge is obtained using a variety of KPI preference setting information. This explores a space of the kinds of performance tradeoffs an operator might want for the cellular communications system 1-11.

The resulting distilled policy 1-3 is used as a starting point for meta training 1-60. Meta training 1-60 approximates an optimal solution in a multi-objective MDP. The approximation is the KPI fast-adaptive AI model, also referred to as meta policy 1-7. The exact optimal solution is a Pareto front and the exact Pareto front may be difficult to achieve due to computational requirements and a volume of training data required. Meta training 1-60 is an efficient approach to finding a solution to the load balancing problem for the cellular communications system 1-11 when there are multiple objectives represented by different sampled tasks 1-62 corresponding to possible different operator objectives for the cellular communications system 1-11. The sampled tasks 1-62 correspond to KPI preferences and may be different than the KPI preference setting information used in the knowledge distillation 1-40.

Overall, Meta training 1-60 is an efficient and accurate solution for the cellular communication system 1-11, and the efficiency is assisted by knowledge distillation 1-40.

More specifically, knowledge distillation 1-40 includes obtaining KPI preference setting information 1-48 and KPI preference setting information 1-50. In general, there may be more than two KPI preference setting information quantities. FIG. 1A discusses two with no loss in generality. Training 1-45 and training 1-51 then provide AI model 1-46 and AI model 1-52, respectively. The AI model 1-46 and AI model 1-52 then interact with an environment 1-53 and provide interaction history 1-47 and interaction history 1-52. An environment is the real world thing that responds to the actions in the MDP and provides the rewards. In the main example used here, the environment is a communication system striving to provide data delivery to user terminals. The rewards are thus metrics of successful data delivery such as throughput, the actions are system adjustments such as determining when handoffs occur in the environment (the communication system). Histories may also be referred to generally as trajectories. The interaction history 1-47 and interaction history 1-52 are stored in a common memory buffer 1-55 and an additional model is obtained by training 1-56. The additional model is distilled policy 1-3.

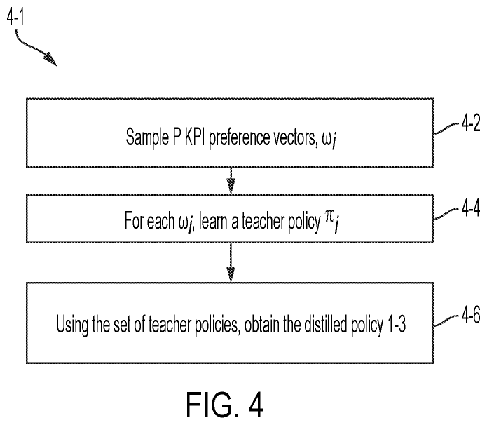

Details of knowledge distillation 1-40 are provided in FIG. 4 and the associated discussion.

Meta training 1-60 is used to initialize sampled tasks 1-62 which then interact with an environment 1-63. A task corresponds to a Markov Decision Process for a given weight vector corresponding to a KPI preference. Environment 1-63 may the same or different from environment 1-53. The interactions provide interaction histories 1-64 which are then used in meta adaptation training 1-66 to produce a KPI fast-adaptive AI model. This model is also referred to herein as meta policy 1-7. Details of meta training 1-60 are provided in FIG. 1C and Table 2 and associated discussion.

FIG. 1B illustrates logic 1-1 for MORL improving load balancing. At operation 1-4, a meta policy 1-7 (meta AI model, also referred to as πₘₑₜₐ) is initialized randomly or using a distilled policy 1-3. At operation 1-6, the meta policy 1-7 is updated using meta learning. At operation 1-8, the meta policy 1-7 is applied to determine parameters 1-9 for load balancing in the cellular communications system 1-11. In some embodiments, the distilled policy 1-3, also referred to as π_{PD}, is obtained with respect KPIs 1-5 of a cellular communication system 1-11.

In embodiments, a policy is a function that maps states (system states of communications systems) to actions (load balancing control parameters). In embodiments, a state is a vector that describes the current status of a system or an environment. For wireless systems, the state can contain information about active users, current IP (data, such as Internet Protocol data) throughput, and/or current cell PRB (physical resource block) usage.

In reinforcement learning (RL), a policy is often approximated using a neural network with learnable parameters θ. A policy may be referred to as π or π_{θ}. The objective of RL methods is to learn optimal parameters θ* by maximizing an agent's expected return (accumulation of rewards received in different time steps). To do so, the agent interacts with its environment by applying the policy π_{θ} and collecting interaction data D=(sₜ, aₜ, rₜ) and performs gradient ascent to maximize its expected return; (sₜ, aₜ, rₜ) refer to the state, action and reward at time step k, respectively.

In general, a policy is approximated using a neural network or a model with learnable parameters θ. Model initialization refers to how these parameters are initialized or first set at the beginning of the learning process. One initialization technique is to randomly sample the parameters from a given distribution. However, learning a neural network using random initialization may take excessive time. To speed up the learning process, the parameters θ can be initialized using other parameters, such as the parameters θ_{PD} of a distilled policy π_{PD} (item 1-3 of FIG. 1).

FIG. 1C illustrates logic 1-21 for improving load balancing according to some embodiments. At operation 1-22, the logic includes obtaining a distilled policy 1-3 based on a first preference vector and a second preference vector. The first preference vector indicates a first weighting over a plurality of KPIs and the second preference vector indicates a second weighting over the KPIs. At operation 1-24, the logic includes initializing the meta policy 1-7 using the distilled policy 1-3. At operation 1-26, the logic includes performing, using the meta policy 1-7, task adaptation. In some embodiments, the task adaptation is for a first task associated with the first preference vector and a second task associated with the second preference vector to obtain first task parameters and second task parameters. At operation 1-28, the logic includes collecting validation trajectories. In some embodiments, the validation trajectories include first validation trajectories and second validation trajectories. The first task is associated with a first task policy and with first task parameters, and the second task is associated with a second task policy and with second task parameters.

Continuing with logic 1-21, at operation 1-30 the logic includes updating meta parameters θₘₑₜₐ, of the meta policy 1-7 using the validation trajectories.

Finally, at operation 1-32, the logic includes applying the meta policy 1-7. In some embodiments, the meta policy 1-7 is applied to perform load balancing in a cellular communications system 1-11.

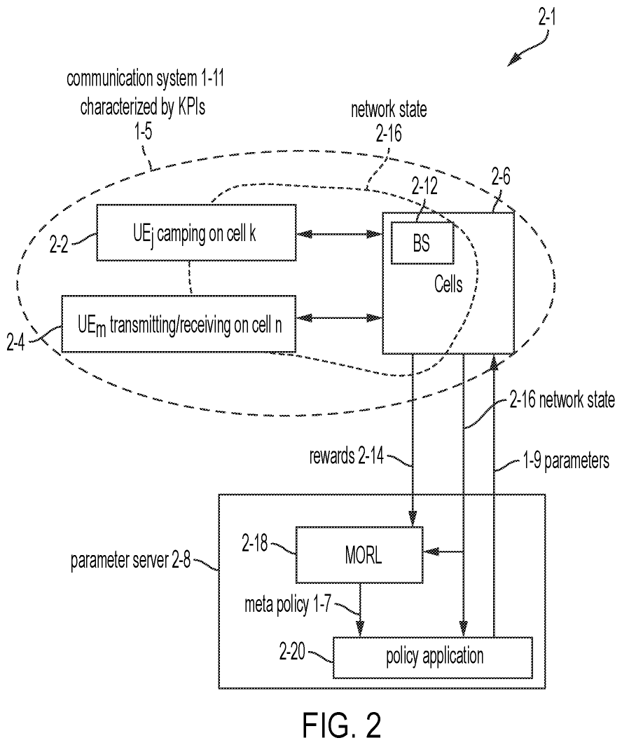

FIG. 2 illustrates a system 2-1 which includes the cellular communication system 1-11 and a parameter server 2-8. Within the cellular communication system 1-11 are user equipments (UEs) and base stations (BSs). A BS supports one or more cells. An example base station (BS) is an gNB (gNodeB) of a 5G network, for example, BS 2-12 of FIG. 2. In an example system, a BS may be located at a site. In an example system, several sites are used to cover a geographic area. A given BS may support several sectors. Each sector may operate over a number of frequency bands. The modulation method may be orthogonal frequency division multiplexing (OFDM). Each UE is served by a given BS, using a particular sector and frequency band. A cell generally refers to a sector and frequency band; the cells of FIG. 2 are referred to collectively as cells 2-6. A UEⱼ of FIG. 2 may be inactive (camping, that is, listening to system messages but generally not transmitting user data) while a UEₘ of FIG. 2 is active (generally transmitting and receiving user data). The camping UEs are referred to collectively as UEs 2-2 and the active UEs are referred to collectively as UEs 2-4.

In FIG. 2, parameter server 2-8 receives information in the form of rewards 2-14 and network state 2-16. The parameter server 2-8 provides parameters 1-9 to the cells 2-6. The parameters 1-9 may also be referred to as mobility parameters. Examples of parameters 1-9 are given in Table 1.

Further details of the re-selection offset between cells can be found in 3GPP TS 38.304, “User Equipment (UE) procedures in idle mode and in RRC Inactive state.” For active UEs, handover is controlled by condition A2 which is X_{c}<Th_{A2} and condition A5 which is that X_{c}<Th_{A2}¹ΛXₙ>Th_{A5}².

TABLE 1

| Parameter symbol | Parameter Name |
|---|---|
| O_{c, n} | Re-selection offset between cell |
| Th_{A2} | Threshold of A2 event indicating weak serving |
| | cell |
| Th_{A5}¹ | One of two parameters of A5 event depending on |
| | the serving cell |
| Th_{A5}² | Second of two parameters of A5 event depending |
| | on the target cell |

The MORL 2-18 of FIG. 2 extends a Markov Decision Process (MDP) framework defined as the tuple (S, A, P, R, Z, ϕ₀).

While cellular communication system 1-11 is operating, observed network state are stored in a buffer. The stored data is a trajectory i of length TT where each point in the trajectory is a tuple of the form (sₖ, aₖ, rₖ) where k indexes time (the k^{th} time step). The trajectory may thus be expressed as i={(s₀, a₀, r₀), . . . , (s_{T}, a_{T}, r_{T})}. Thus a trajectory is a sequence of state, action and reward obtained by running some policy π on an environment E (for example, cellular communication system 1-11) for TT consecutive time steps. The environment E is defined by a geographical placement of base stations, resource allocation in terms of bandwidth, and a set of statistics indicating traffic demand for a geographical distribution of camping UEs and a geographical distribution of active UEs (for example, see the discussion above of camping UEs 2-2 and active UEs 2-4).

A task corresponds to a Markov Decision Process for a given weight vector ωᵢ corresponding to KPI preferences. In other words, for a given weight vector ωᵢ, the reward function becomes the weighted sum of the objectives. Different weight vectors ωᵢ result in different reward functions and thus different policies. In an example, a task is defined by a weight vector. Embodiments disclose learning a single policy πₘₑₜₐ that can perform well for different tasks and hence for different weight vectors between different system KPIs. Training a policy on a weight vector ωᵢ does not necessarily perform well on another task ωⱼ. Hence, the use of meta-reinforcement learning as a solution concept for the multi-objective load balancing problem solved by embodiments provided herein.

As mentioned above, policy distillation (also referred to as knowledge distillation) is a mechanism to combine knowledge from different expert policies into a single policy. The basic policy distillation algorithm consists of two main stages.

Expert policies (teacher policies) are obtained as follows. In a first stage p expert policies are learned for different p tasks. A task corresponds to a specific weight vector ωᵢ for multiple KPIs. An expert policy is an RL policy trained on a given preference weight vector to the maximum performance. After this stage, each expert policy achieves the best solution for a given weight vector ωᵢ.

The distilled policy is obtained to mimic the behaviors of expert policies. To do so, the algorithm uses data collection and policy distillation. In data collection, the algorithm collects interaction data Dₑ={sₜ, aₜ, sₜ₊₁, rₜ} from expert or teacher policies (as mentioned before, these expert policies are learned on different KPI preference vectors) and stores the data in a common memory buffer. During policy distillation the distilled policy π_{PD} is initialized randomly (i.e., elements of π_{PD} are random samples governed by some distribution). The distilled parameters π_{PD} are learned using the collected data from experts. Specifically, the distilled parameters are updated using gradient descent to minimize the difference between the experts' actions and the distilled policy actions. Various loss functions may be used; see Equations 7, 8 and 9. Once the optimization is done, the distilled policy represents an aggregate of knowledge from all the experts and will achieve similar good performance on all the considered tasks.

In an MDP framework (for example Multi-Objective MDP MOMDP), S is a state space, A is an action space, P(sₜ₊₁∨sₜ, aₜ) is the transition probability function, R(sₜ, aₜ) is the reward function returning a vector of m rewards [r₁, . . . , rₘ]^{T} where m is the number of objectives (number of KPIs), Z is the discount factor and ϕ₀ is the initial state distribution. For a given policy π, the expected discounted return is defined as J^{π}=[J₁^{π}, . . . , Jₘ^{π}]^{T} such that the result of Eq. (1) is obtained.

Jᵢ^{π}=E[Σₜ₌₀^{H}Z^{t}rᵢ(sₜ,aₜ)∨s₀˜ϕ₀,aₜ˜π]

Equation (1) defines one objective of the multi-objective in MORL.

The policy π which solves the max J expression below may be referred to as providing a Pareto front.

Maximizing the expected discounted return requires solving the problem

$${max}_{π} {J}^{π} = {{max}_{π} [ {J}_{1}^{π} , … , {J}_{m}^{π} ]}^{T} .$$

Embodiments provide performance approaching the solution of Eq. 1 using a meta policy approach. The meta policy approach approximates the Pareto front. In embodiments provided herein, an initial meta policy is fine-tuned for a set of preferences for a small number of iterations.

To learn the meta-parameters θₘₑₜₐ, embodiments start by sampling N weight vectors and train N policies for each task using K gradient updates. This step is called task adaptation. At the end of the task adaptation, the algorithm will have N policies parameters θᵢ for each task i. Each policy πᵢ performs well for a corresponding weight vector ωᵢ. The next step is updating the meta-policy using the obtained parameters {θᵢ}ᵢ₌₁^{N}.The meta policy πₘₑₜₐ is updated by aggregating the errors from the N tasks. These two steps are repeated for a given number of meta iterations Nₘₑₜₐ and, at the end, the algorithm obtains the meta-control policy, πₘₑₜₐ.

As mentioned above, in meta-RL, an agent strives to learn a policy with parameters θ that solve multiple tasks from a given distribution p(T). Each task Tᵢ is an MDP defined by its inputs sᵢ its outputs aᵢ, a loss function Lᵢ, a transition function Pᵢ, a reward function Rᵢ and an episode length, Hᵢ. Generally, meta-RL methods have two steps and two task sets: the meta-training tasks Tₜᵣₐᵢₙ and meta-testing or fine tuning where the agent is evaluated on a set of test tasks Tₜₑₛₜ. It is assumed that both training and testing task sets are drawn from the same distribution p(T), but Tₜₑₛₜ can be different from Tₜᵣₐᵢₙ. Each task Tᵢ has both training and validation data Dᵢ={Dᵢ^{train},Dᵢ^{val}}. For each task, the goal is to learn task-specific parameters θᵢ=Alg (θ, Dᵢ^{train}) starting from θ using Dᵢ^{train} such that the loss Lᵢ on the validation set Dᵢ^{val} is minimized. The final general policy obtained as θmeta may be referred to, during training, as either as θ with no subscript or referred to θₘₑₜₐ. Alg(·) refers to the algorithm used to update the task specific parameters θᵢ. For example, gradient-based meta-RL methods such as Model Agnostic Meta Learning may be used. The meta-training phase is a bi-level optimization problem where the objective is to learn the optimal meta-parameters as shown in Eq. 2 and Eq. 3.

$${θ}_{meta} = arg min F ( θ ) , where the min is over θ \qquad Eq . 2$$

$$F ( θ ) = ( \frac{1}{{T}_{train}} ) {\sum }_{i = 1}^{{T}_{train}} {L}_{i} ( Alg ( θ , {D}_{i}^{train} ) , {D}_{i}^{val} ) \qquad Eq . 3$$

The inner optimization (in the argument of Lᵢ) may be solved using one or more gradient descent steps using Eq. 4, in which β is the step size of the inner level optimization.

θᵢ=Alg(θ,Dᵢ^{train})=θ−β∇_{β}Lᵢ(θ,Dᵢ^{train}) Eq. 4

For the multi-objective load balancing problem, each task Tᵢ is an MDP corresponding to a specific weight vector ωᵢ. In one example, the solution is a gradient-based meta-RL method as described in Equations 2, 3 and 4.

The state, action and reward of the learning problem of Eq. 2 correspond to the network state 2-16, the chosen parameters 1-9 and functions related to system performance such as Tₘᵢₙ and T_{std}. In an example, the state value includes the number of active UEs per frequency channel, the load for each frequency channel and the throughput per frequency channel. The action is selection of the parameters 1-9 (see Table 1). The rewards, in a non-limiting example, are

$${r}_{1} = ( \frac{1}{4.9} ) {T}_{min} and {r}_{2} = ( \frac{1}{2.4 ⋆ ( 1 + {T}_{std} )} ) .$$

The coefficients 4.9 and 2.4 are only examples and do not limit the embodiments. The rewards have different scales and the scaled reward functions allow them to be combined. The scaling factors can be found by a grid search over a set of plausible values. The best factors in terms of rewards are selected. The technique of reward engineering can be used.

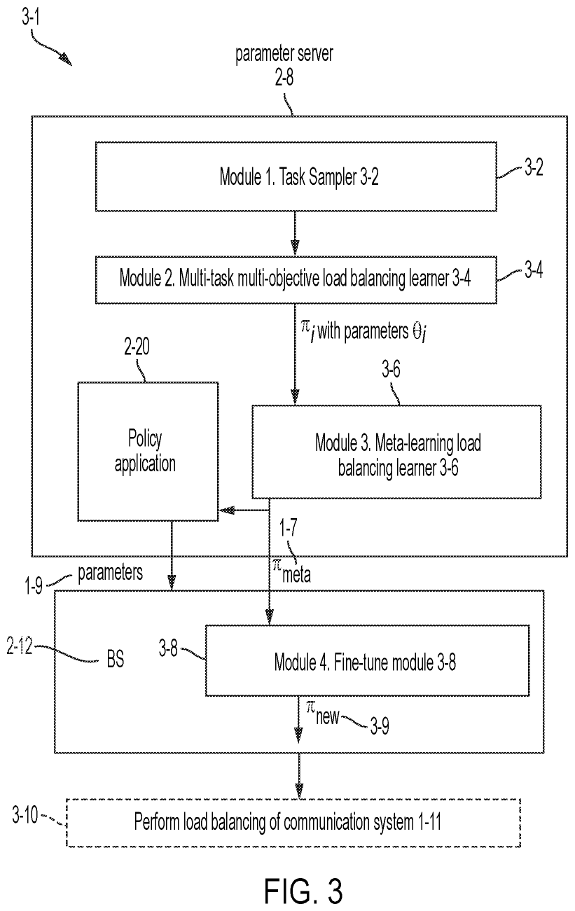

The learning problem expressed in Eq. 2 is solved by alternating two optimization steps: (i) task adaptation Alg (inner level) where a number of task-specific policies are learned starting from the meta-policy parameters θₘₑₜₐ, (ii) meta-adaptation (outer level) that adjusts the meta-parameters using trajectories sampled from the adapted policies (see FIG. 3a). These two steps are repeated for a fixed number of meta-iterations (Nmeta). Once the training is finished, the meta-policy can be used as an initialization to quickly learn the optimal solutions for new tasks. In particular, the Pareto front can be approximated by fine tuning the meta-policy for several iterations for multiple preferences. Algorithm 1 in Table 2 summarizes the MeMo LB framework.

For task adaptation, N preference vectors are randomly sampled from a specific distribution p(ω) such that each weight element (ωᵢ)ⱼ is positive and the elements of ωᵢ sum to 1. For each ωᵢ, the loss function is given by Eq. 5.

L₁(θ₁,ω₁)=−E_{{s}_{ₜ}_{,a}_{ₜ}_{π}_{ₘₑₜₐ}_{}}Σ{ω₁^{T}(\hat{r}(sₜ,aₜ)−V(sₜ))} Eq. 5

where the sum Σ is over t=0 to H₁, \hat{r} is a reward, sₜ is a state in a first MDP at time t, aₜ is an action in the first MDP at the time t, and E is an expectation operator over states and actions defined by the meta policy πₘₑₜₐ. To estimate the gradients of the loss in Eq. 5, trajectories Dᵢ^{train} are collected by running the meta policy in an environment governed by a Markov Decision Process of the i^{th} task Tᵢ, and a training trajectory is represented as {s₁, a₁, r₁, . . . , s_{H}, a_{H}, r_{H}}∈D^{train}, D^{train} comprises a set of training trajectories, and H is an episode horizon for the i^{th} task Tᵢ. Task specific parameters θᵢ are obtained using one or more gradient steps of Eq. 4.

Meta adaptation is performed as follows. A meta-learner aggregates trajectories Dᵢ^{val} sampled using policies π_{θ}_{ᵢ} from the task adaptation and adjusts the meta- policy parameters θₘₑₜₐ by differentiating through the adaptation phase to minimize the errors estimated using Dᵢ^{val} as in Eq. 6.

θ→θ−η∇_{θ}Σᵢ₌₁^{N}Lᵢ(θᵢ,ωᵢ) Eq. 6

Meta MORL may be implemented as described by Algorithm 1 as provided in Table 2.

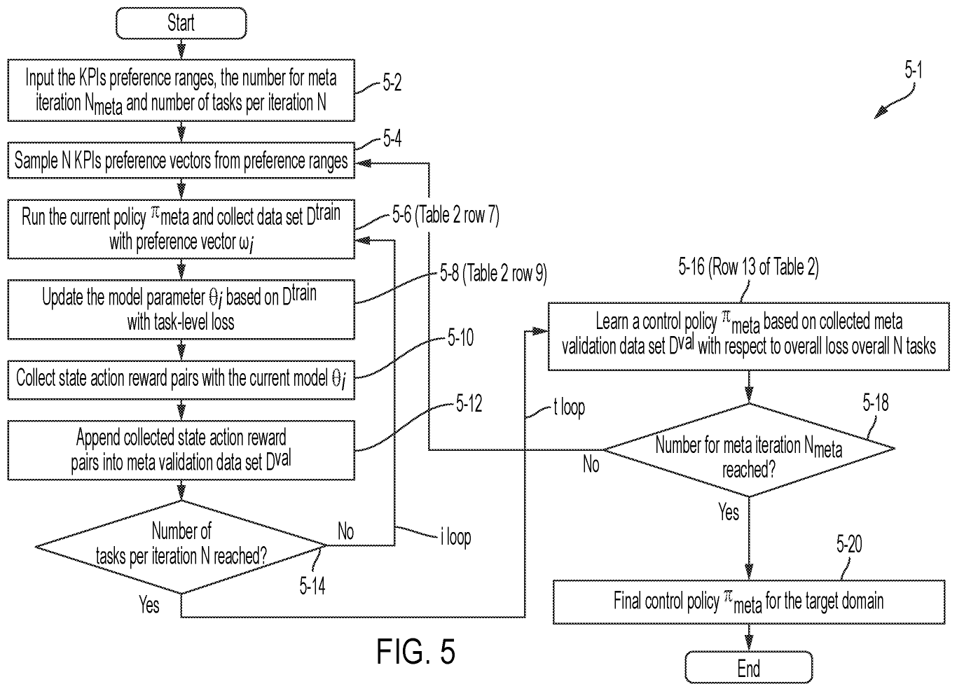

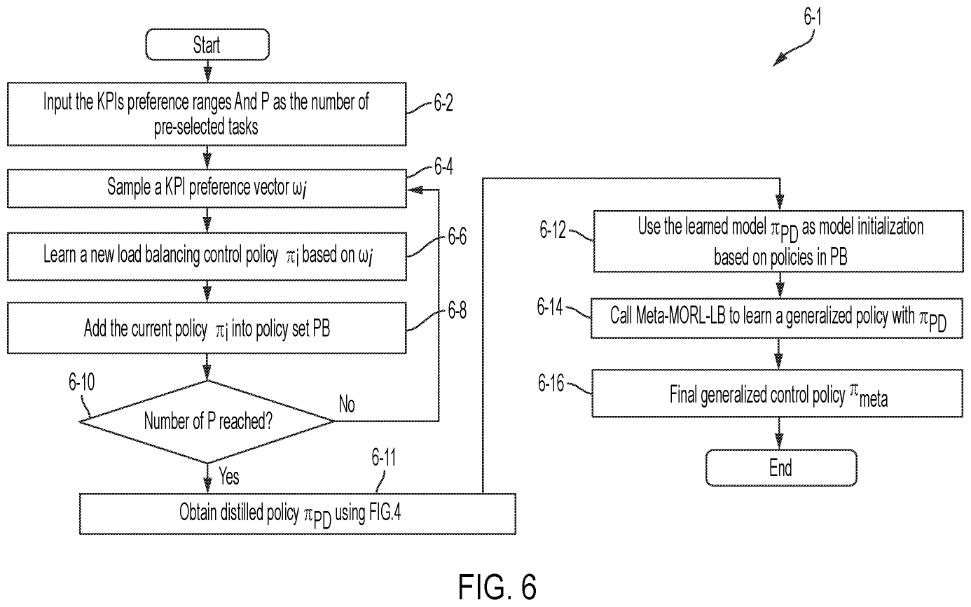

TABLE 2
Meta MORL for load balancing (also see FIGS. 5 and 6).

| Item | Description |
|---|---|
| 1 | Input: p(ω): the preferences distribution, Nₘₑₜₐ: number of meta |
| | iterations, N: number of tasks per meta iteration, K: number of |
| | trajectories sampled per task. |
| 2 | Initialize meta policy πₘₑₜₐ randomly or using π_{PD}. |
| 3 | For t = 1 to Nₘₑₜₐ do \\t loop |
| 4 | Task Adaptation |
| 5 | Sample N preference vectors ωᵢ ~ p(ω); |
| 6 | For i = 1 to N do (each preference vector ωᵢ) \\ i loop |
| 7 | Sample K trajectories Dᵢ^{train} using πₘₑₜₐ |
| 8 | Estimate the gradient with respect to |
| | (θₘₑₜₐ) of Lᵢ (θₘₑₜₐ, ωᵢ) using Dᵢ^{train} |
| 9 | Compute the adapted parameters θᵢ using Eq. 4 |
| 10 | Collect trajectories Dᵢ^{val} using the adapted policy πᵢ with |
| | parameters θᵢ in Tᵢ. |
| 11 | end for \\i loop |
| 12 | Meta Adaptation |
| 13 | Update πₘₑₜₐ as in Eq. 6 using Dᵢ^{val} and ωᵢ . |
| 14 | end for \\ t loop |
| 15 | Fine-tune: fine-tune the meta policy πₘₑₜₐ for a number of |
| | iterations using Eq. 4 to approximate the Pareto front. |

The “Meta Adaptation” portion of Table 2 is performed Nₘₑₜₐ times (see the “t loop”). That is, meta adaptation includes performing, for example, an iteration of meta adaptation to improve the meta policy by repeating: i) performing, using the meta policy, task adaptation (line 9 of Table 2), ii) collecting, as a non-limiting example, first validation trajectories and second validation trajectories (line 10 of Table 2), and iii) updating, as a non-limiting example, the plurality of meta parameters of the meta policy using the first validation trajectories and the second validation trajectories (line 13 of Table 2).

The challenging task of learning a general meta-policy is accomplished by embodiments provided herein. First, the task adaptation step explained above includes the collection of trajectories for each task. Generally, the number of these trajectories is limited to ensure the adaptation with few samples. Further, θₘₑₜₐ and θᵢ have the same parameter space which could be in the order of millions in deep neural networks. Additionally, learning one initial condition for a large family of tasks is not trivial. To account for these challenges, some of the embodiments provided herein use policy distillation to combine the knowledge from different tasks into a single policy which will be used to initialize the meta-training. This provides better task-specific policies with fewer samples since the algorithm assumes that some of the preferences encountered during the task adaptation phase can be similar to the tasks used during policy distillation.

An achievement of MORL LB (and Meta MORL LB) is using known tasks to learn a task policy for a new task, when the new task is a previously-unseen task.

As mentioned above, in some embodiments, policy distillation is used to initialize the meta policy (that is, to initialize πₘₑₜₐ. The policy distillation stage starts by selecting P≠N preferences {ω₁, . . . , ωₚ} and training P task-specific policies for each weight vector to maximum performance. The task-specific policies may be referred to as teachers or experts. Next, the trained teachers with parameters θᵢ, for task i (task Tᵢ, also referred to as Eᵢ), are used to collect trajectories which will be saved in separate memory buffers. The distilled policy π_{PD} is learned to match the teachers' state-dependent action probability distributions π_{θ}_{ᵢ} by minimizing the Kullback-Leibler (KL) divergence as shown in Eq. 7.

$${L}_{K L} ( {θ}_{PD} , s ) = {\sum }_{i = 1}^{p} {\sum }_{a ∈ A} {π}_{{θ}_{i}} ( a \vert s ) log ( \frac{{π}_{{θ}_{i}} ( a \vert s )}{{π}_{{θ}_{P D} ( a \vert s )}} ) \qquad Eq . 7$$

An alternative expression of the KL divergence uses a temperature parameter the KL divergence being then expressed as

$${\sum }_{i = 1}^{D} softmax ( \frac{{q}_{i}^{T}}{τ} ) ln \{ \frac{softmax ( \frac{{q}_{i}^{T}}{τ} )}{softmax ( {q}_{i}^{S} )} \} .$$

The Q values of this expression are described below in the discussions of negative log likelihood loss and mean-squared-error loss.

In an example using Eq. 7, the AI model parameters of a first task π₁ are first task parameters θ₁ and are found using model-free reinforcement methods.

In example, related to Eq. 7 and to FIG. 4, initializing first task parameters (for example, FIG. 4 operations 4-2 and 4-4, including initializing AI model parameters of a first task π₁ are first task parameters θ₁) includes selecting a first plurality of preferences ωᵢ (see operation 4-2) training a first plurality of task policies {π₁, π₂, . . . } (see operation 4-4). In terms of terminology, the first plurality of task policies may be referred to as a first plurality of teachers. As mentioned above, policy distillation includes collecting a first plurality of trajectories using a first plurality of teachers; training the distilled policy to match state-dependent action probability distributions of the first plurality of teachers (see Eq. 7) and initializing the task parameters θₘₑₜₐ, using the distilled policy π_{PD}.

Alternative loss functions may be used. The loss functions of Eq. 8 and Eq. 9 use q values. As background, Q-learning is a model-free reinforcement learning algorithm to learn the value of an action in a particular state. Q-learning finds an optimal policy in the sense of maximizing the expected value of the total reward over any and all successive steps, starting from the current state. Q-learning can identify an optimal action-selection policy. The algorithm computes a function corresponding to the expected rewards, q (also called Q-values), for an action taken in a given state.

In Eq. 8, a negative log likelihood loss is provided. Negative log likelihood loss is a loss function to measure how the new student policy can perform; the lower the better. In Eq. 8, D is the data set, a₁ is an action, a_{i,best} is the highest value action, xᵢ is the state, for example, the network state 2-16. θₛ are the student model parameters (for example θᵢ. The state of the network, an input to the AI model πₘₑₜₐ, can contain information about active users, current IP (data, such as Internet Protocol data) throughput, and/or current cell PRB (physical resource block) usage.

In Eq. 8, a_{i,best}=argmax (qᵢ), where qᵢ is a vector of unnormalized Q-values with one value per action.

L=−Σᵢ₌₁^{D}logP(aᵢ=a_{i,best}|xᵢ,θₛ) Eq. 8

In an example of Eq. 8, the distillation loss function expresses a negative log likelihood loss.

In Eq. 9, a mean-squared-error loss is provided describing a squared loss between a student model (distilled policy) and a teacher model (πᵢ with parameters θᵢ for task Tᵢ. The mean-squared-error loss is a loss function to measure the distance for the outputs of the actions determined by the student policy and the actions determined by the teacher policy. In Eq. 9, qᵢ^{T} refers to the Q-value of the teacher for the i^{th} input data and qᵢ^{S} refers to the Q-value of the student for the iₜₕ input data.

L=Σᵢ₌₁^{D}∥qᵢ^{T}−qᵢ^{S}∥₂² Eq. 9

In an example of Eq. 9, the distillation loss function expresses a mean-squared error loss.

When considering a reinforcement learning problem, a suitable loss function can be chosen on whether the outputs are discrete values (use negative log likelihood loss or mean-squared error loss) or continuous (use KL divergence loss).

Policy distillation, in some embodiments, is a first stage. The second stage of Meta MOPD LB is the training of πₘₑₜₐ using π_{PD} as initialization (also see FIG. 5). The same training procedure as in Me MO LB is followed.

FIG. 3 illustrates a system 3-1. Module 1, which is the task sampler 3-2, may be implemented at parameter server 2-8. Module 2, the multi-task multi-objective load balancing learner 3-4, receives the output of module 1, and may be implemented at the parameter server 2-8. Module 3, the meta-learning load balancing learner 3-6, receives the output of 3-4 and may also be implemented at the parameter server 2-8. In some embodiments, module 4, which receives πₘₑₜₐ from the parameter server, produces a policy π_{new} 3-9 using fine-tuning and determines parameters 1-9 using π_{new}.

As shown in FIG. 3, in some embodiments, the parameter server 2-9, using πₘₑₜₐ 1-7 determines parameters 1-9 based on network state 2-16 and provides the parameters 1-9 to the BS 2-12.

At an operation 3-10, the BS 2-12 performs load balancing using parameters derived either directly from πₘₑₜₐ 1-7 or parameters derived after fine-tuning πₘₑₜₐ (that is, directly from π_{new} 3-9).

FIG. 4 illustrates logic 4-1 for performing a student-teacher algorithm. At operation 4-2, P KPI preference vectors, ωᵢ, are sampled. Each ωᵢ is an example of preference over the KPIs 1-5. At operation 4-4, for each ωᵢ, a teacher policy πᵢ, is learned. At operation 4-6, a student policy is obtained in the form of the distilled policy (π_{PD}) 1-3 being learned.

FIG. 5 illustrates logic 5-1 for obtaining meta policy (πₘₑₜₐ) 1-7 without using a distilled policy. FIG. 5 is an example of MORL 2-18 of FIG. 2. At operation 5-2, At operation 5-2, KPI preference ranges, a number of meta iterations and a number of tasks per iteration are provided as inputs. At operation 5-4, N preference vectors ωᵢ are selected stochastically from the preference ranges. At operation 5-6, the policy πₘₑₜₐ is used in the target environment with preference vector ωᵢ and a data set D^{train} of trajectories is collected (also see row 7 of Table 2). Each point in a given trajectory is a tuple (state, action, reward). At operation 5-8, the model parameters θᵢ is updated based on D^{train} with task level loss. At operation 5-10, state, action, reward tuples are collected with the current model θᵢ. The collected state, action, reward tuples are appended into a meta validation set D^{val}. Operation 5-14 is a decision diamond determining if there are more tasks to be run before determining a new set of tasks. If N tasks have been completed, the logic flows to operation 5-6 (also see Table 2 row 13). Otherwise, the logic flows by the arrow labelled “i loop” to operation 5-16. At operation 5-16, πₘₑₜₐ is updated based on Dᵥₐₗ. Operation 5-18 is a decision diamond determining whether πₘₑₜₐ has been updated Nₘₑₜₐ times. If yes, the logic flow is completed. If no, the logic flows back via the “t loop” to operation 5-4.

Logic flow 6-1 illustrates obtaining πₘₑₜₐ by using an initialized policy of π_{PD}. FIG. 6 is an example of MORL 2-18 of FIG. 2. At operation 6-2, inputs including KPI preference ranges and P as the number of tasks are used to find π_{PD}. That is, there are P teachers (or experts). At operation 6-4, a KPI preference vector ωᵢ is sampled from the i^{th} preference ranges. At operation 6-6, a new load balancing control policy πᵢ is learned based on ωᵢ. The learned policy πᵢ is placed in the policy set (policy bank) PB. Operation 6-10 is a decision diamond determining if another teacher is to be obtained; if yes, the logic flows back to operation 6-4. If no, the logic flows to operation 6-11 and the distilled policy π_{PD} is obtained using FIG. 4. At operation 6-12, the initial value of πₘₑₜₐ is set to π_{PD}. The pseudocode of Table 2 (equivalent to FIG. 5) is then used to obtain πₘₑₜₐ (the meta policy 1-7), which is output at operation 6-16.

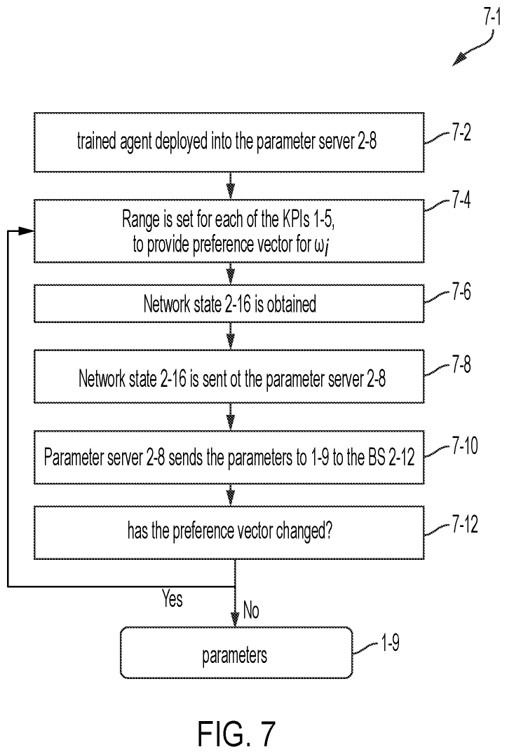

FIG. 7 illustrates logic 7-1 for learning the parameters 1-9 at a training server (not shown) and then providing the parameters to a different server performing as the parameter server. At operation 7-2, a trained agent is deployed into the parameter server 2-8. The agent includes software for implementation of modules 1, 2 and 3 of FIG. 3. At operation 7-4 a range is set for each of the KPIs 1-5, this provides a preference vector ωᵢ. In some embodiments ωᵢ is a vector of scalars, and in alternative embodiments may be a vector of ranges. At operation 7-6, network state 2-16 is obtained and at operation 7-8 the network state 2-16 is sent to the parameter server 2-8. At operation 7-10, the parameter server 2-8 sends the parameters 1-9 to the BS 2-12. At operation 7-12, if the preference vector ωᵢ has changed, the logic flows back to operation 7-4; this may include, for example, a change in the acceptable range for each KPI of KPIs 1-5. If the preference vector has not changed, then the parameters 1-9 are stable.

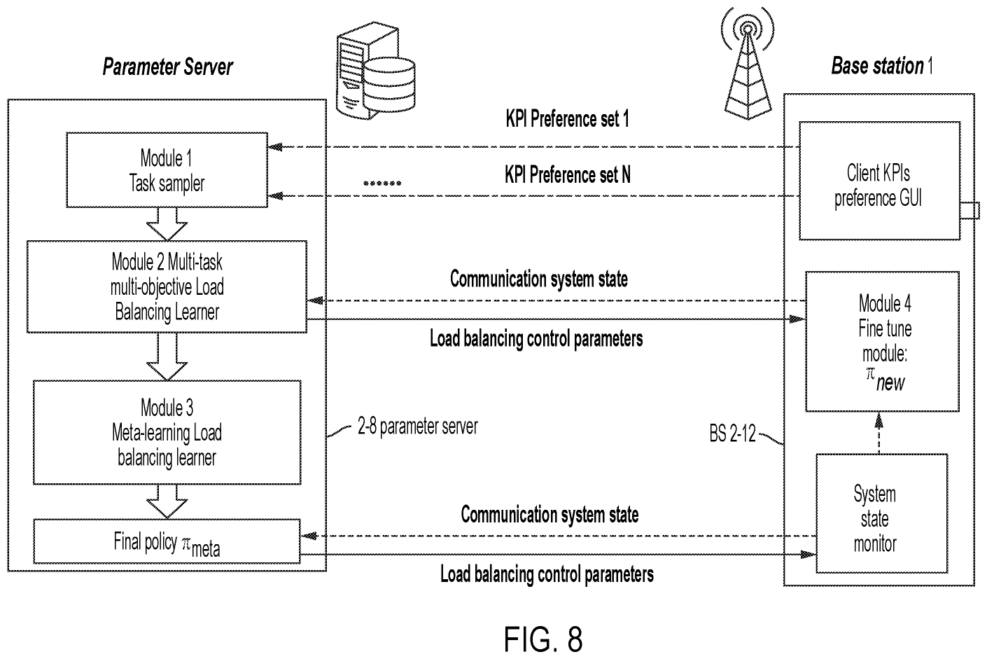

FIG. 8 illustrates parameter server 2-8 in communication with BS 2-12.

BS 2-12 may provide a graphic user interface (GUI) for entry of KPI weights preferred by the operator of BS 2-12. The BS 2-12 then sends KPI preference set 1 through KPI preference set N to the parameter server 2-8, where they are input to module 1. Module 2 then performs the i loop of Table 2 based on the target system; also see FIG. 5 operations 5-6 to 5-14. Module 2 in the parameter server 2-8 receives communication system state (network state 2-16) from BS 2-12 and the parameter server 2-8 provides parameters 1-9. This is the training phase. Meta learning is then applied by module 3 and πₘₑₜₐ is obtained (meta policy 1-7). At the BS 2-12, fine-tuning may be performed on πₘₑₜₐ to obtain π_{new}.

Regarding FIG. 8, functions in the parameter server 2-8 and the BS 2-12 have various inputs and outputs. For example, Module 1 has inputs of ranges for the preferences of different KPIs and outputs being a number of possible KPI preference combinations. Module 2 has inputs of a number of possible KPIs preference combinations and outputs of the distilled policy 1-3 (π_{PD}). Module 3 has inputs of a number of possible KPIs preference combinations with distilled policy 1-3 (π_{PD}) as model initialization and an output of meta policy 1-7 (πₘₑₜₐ). Overall, the parameter server 2-8 has inputs of real-time system observations and outputs parameters 1-9 (load balancing control parameters). In BS 2-12, the preference GUI has inputs controlled by a telecom company engineer entering ranges (preferences) for each KPI. BS 2-12 includes a system state monitor which accumulates system observations (including monitoring the current status of the network system and recording the measurements of different KPIs) to provide to module 4 (fine tune module), which produces π_{new}.

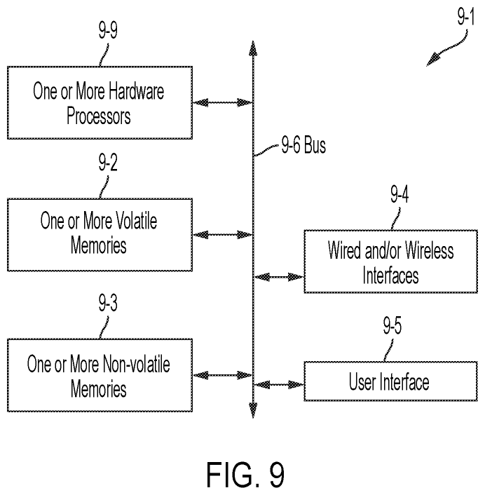

In an implementation example, base stations (including BS 2-12) interconnect with each other via an LTE X2interface. Once a handover decision is made from one BS to another BS, relevant information is exchanged through the X2 interface. In some embodiments, BS 2-12 uses the parameters 1-9 to perform load balancing in the cellular communications system 1-11. As shown in FIGS. 3 (item 3-8) and FIGS. 8-9, the BS 2-12 may fine tune πₘₑₜₐ to obtain a policy π_{new}. In an alternative embodiment, the BS 2-12 then applies network state 2-16 as an input to π_{new} and obtains parameters 1-9 for balancing traffic flowing through BS 2-12.

Whether the BS 2-12 obtains parameters 1-9 from the parameter server 2-8 or locally using π_{new}, the BS 2-12 then is able to achieve improved load balancing of the different frequency bands with each sector of cellular communication system 1-11 shown in FIG. 2.

In some embodiments, Meta-MORL for load balancing is deployed in three phases: offline phase, staging phase and online phase.

In the offline phase, field data is collected to generate real-world traffic patterns and performance records. These traffic scenarios are used to calibrate simulation parameters to mimic real-world dynamics. Specifically, πₘₑₜₐ is trained over degrees of freedom of number of UEs per frequency channel, traffic conditions such as request interval, file size, variations in demand over the different hours of the day, and traffic volume being a high traffic volume or a low traffic volume, for example.

In an example, the πₘₑₜₐ AI model has three hidden layers of 256 units each. Policy gradients may be computed using REINFORCE, as is known in the art. Trust-region policy optimization (TRPO) may be used for meta-adaptation. The value function used in both task and meta-adaptation phases, is a linear feature model fitted separately for each task. The learning rate β may be 0.1 during the meta-training and 0.003 for the finetuning phase. The episode length may be H=24 time steps. In each meta iteration N=5 tasks may be used and K=10 trajectories may be sampled. Preferences may be sampled from a Gaussian distributions, being restricted to be positive and Lᵢ normalized. In an example, πₘₑₜₐ for MeMo-LB and MeMoPD-LB are trained for 500 meta-iterations. For policy distillation, the teacher and student models may have the same architecture as the meta-policy. In an example, p=3 expert (teacher) policies are trained using proximal policy optimization (PPO).

A comparison of results is provided below in Table 3. It is good for Tmin to be high and Tstd to be low.

TABLE 3

| | Low Traffic | | High Traffic | |
|---|---|---|---|---|
| Algorithm | Tmin (Mbps) | Tstd | Tmin (Mbps) | Tstd |
| No LB | 5.10 | 4.19 | 1.73 | 5.89 |
| Static LB (fixed thresholds | 5.40 | 4.34 | 1.80 | 4.48 |
| for all traffic scenarios) | | | | |
| Adaptive LB (adapts the | 5.43 | 4.05 | 1.95 | 4.33 |
| thresholds based on the | | | | |
| cells' load measurements) | | | | |
| MeMo-LB | 5.92 | 3.53 | 2.35 | 3.90 |
| MeMoPD-LB | 6.01 | 3.56 | 2.39 | 3.74 |

The Pareto front has been considered in order to evaluate the quality of the approximated Pareto fronts.

A measure of the quality of the approximated Pareto front is the hypervolume indicator, see Table 4.

TABLE 4

| | Hypervolume Indicator | | | | |
|---|---|---|---|---|---|
| | | | | | PFA |
| | | | RA | RS | (pareto |
| | | | (radial | (random | following |
| Traffic | MeMoPD-LB | MeMo-LB | algorithm) | selection) | algorithm) |
| Low | 0.92 | 0.82 | 0.76 | 0.67 | 0.75 |
| High | 2.09 | 1.67 | 1.53 | 1.65 | 1.63 |

Embodiments thus provide a better approximation in the multi-objective problem situation than the baselines.

Also, during fine-tuning (see FIGS. 3, 8 and 9), embodiments achieve a given level of the hypervolume indicator with fewer gradient steps compared to the baseline methods.

Augmenting the meta-training with policy distillation provides better performing individual policies. In an example for 300 different preferences, ωᵢ, the realized rewards are higher for MeMoPD-LB compared to MeMo-LB for 90% of the preferences. This is with the same number of samples and gradient steps.

Thus, embodiments provide a general parameterized policy, πₘₑₜₐ, which can be adopted to new preferences with fewer samples and gradient steps. This meta policy is a differentiable solution which can be optimized end-to-end over a set of training preferences. MeMo-LB and MeMoPD-LB can be applied to complex, high-dimensional real-world control problems even with a limited number of samples and tasks (preferences). The multi-objective approach of embodiments is more effective to improve cellular network performance than single policy and traditional rule-based approaches. Policy distillation improves the generalization of the meta-policy by providing a task-specific starting point for the meta-training.

To assist in understanding, a list of symbols is provided in Table 5.

TABLE 5
List of symbols.

| Row | Symbol | Comment |
|---|---|---|
| 1 | (S, A, P, R, Z, Φ₀) | State and action spaces, transition |
| | | probability function, discount factor, |
| | | initial state distribution. |
| 2 | m | Number of objectives |
| 3 | R, ∇ᵢ, \hat{rᵢ} | Reward function, immediate reward, the |
| | | return of the objective |
| 4 | πₘₑₜₐ, πᵢ | Meta policy and policy for task i |
| 5 | J^{π}, Jᵢ | Vectorized expected discounted return |
| | | and expected discounted return of the |
| | | ith objective |
| 6 | H | Episode horizon |
| 7 | F | Pareto front |
| 8 | ωᵢ | Preference vector of the ith task |
| 9 | Tₜᵣₐᵢₙ, Tₜₑₛₜ | Train and test task data sets |
| 10 | Lᵢ, Pᵢ, Rᵢ | Loss, transition probability and |
| | | reward functions for the ith task |
| 11 | Dᵢ^{train}, Dᵢ^{val} | Train and validation data sets for the |
| | | ith task |
| 12 | Vᵢ | Estimated value function for the ith |
| | | task |
| 13 | β, η | Step size for the task adaptation and |
| | | meta-adaptation phases |
| 14 | N | Number of tasks sampled in each meta- |
| | | iteration |
| 15 | K | Number of trajectories collected for |
| | | each task |
| 16 | Nₘₑₜₐ | Number of meta-training iterations |
| 17 | P | Number of tasks used for policy |
| | | distillation (number of teachers) |
| 18 | Eᵢ | Expert policy used for policy |
| | | distillation (also called ith teacher) |
| 19 | θ_{PD}, θᵢ | AI model parameters of the distilled |
| | | policy and of the ith expert policy |
| | | respectively |

The embodiments provided above are not limited to cellular systems. For example, the embodiments described above are also applicable to intelligent transportation networks in which traffic congestion is a problem and load balancing will relieve traffic congestion. In terms of KPIs 1-5, objectives are traffic waiting time, delay, and queue length. For example, objectives are waiting time given by the sum of the times that vehicles are stopped. Delay is the difference between the waiting times of continuous green phases. Queue length is calculated for each lane in an intersection. Embodiments above simultaneously optimize the different metrics and quickly adapt to new unseen preferences depending on the intersection and the region.

For another example, the embodiments described above are also applicable to smart grid/smart home in which energy consumption is a problem and load balancing will reduce energy consumption. In terms of KPIs 1-5, objectives are operational cost of the smart grid and the environmental impact (e.g., greenhouse gas emission). Embodiments above can be applied to provide intelligent optimal policies for a better energy consumption.

Hardware for performing embodiments provided herein is now described with respect to FIG. 9.

FIG. 9 illustrates an exemplary apparatus 9-1 for implementation of the embodiments disclosed herein. For example, each of parameter server 2-8, and base station 2-12 may be implemented using the apparatus 9-1. Similarly, the training server mentioned with respect to FIG. 7 may be implemented using an instance of the apparatus 9-1. The apparatus 9-1 may be a server, a computer, a laptop computer, a handheld device, or a tablet computer device, for example. Apparatus 9-1 may include one or more hardware processors 9-9. The one or more hardware processors 9-9 may include an ASIC (application specific integrated circuit), CPU (for example CISC or RISC device), and/or custom hardware. Apparatus 9-1 also may include a user interface 9-5 (for example a display screen and/or keyboard and/or pointing device such as a mouse). Apparatus 9-1 may include one or more volatile memories 9-2 and one or more non-volatile memories 9-3. The one or more non-volatile memories 9-3 may include a non-transitory computer readable medium storing instructions for execution by the one or more hardware processors 9-9 to cause apparatus 9-1 to perform any of the methods of embodiments disclosed herein.

Provided herein is a method of multi-objective reinforcement learning load balancing, the method comprising: initializing a meta policy; performing, using the meta policy, task adaptation for a first task associated with the first preference vector and a second task associated with the second preference vector to obtain a plurality of first task parameters and a plurality of second task parameters; collecting one or more first validation trajectories and one or more second validation trajectories, wherein the first task is associated with a first task policy and with first task parameters, and the second task is associated with a second task policy and with second task parameters; updating a plurality of meta parameters of the meta policy using the one or more first validation trajectories and the one or more second validation trajectories; and applying the meta policy to perform load balancing in a cellular communications system.

In some embodiments, the method further comprises initializing the first task parameters based on the plurality of meta parameters using policy distillation.

In some embodiments initializing the first task parameters comprises: selecting a first plurality of preferences; training a first plurality of task policies, wherein the first plurality of task policies correspond to a first plurality of teachers; collecting a first plurality of trajectories using the first plurality of teachers; training the distilled policy to match state-dependent action probability distributions of the first plurality of teachers; and initializing the first task parameters using the distilled policy.

In some embodiments, the multi-objective reinforcement learning load balancing uses known tasks to learn a task policy for a new task, wherein the new task is a previously unseen task.

In some embodiments, the method further comprises fine tuning the meta policy using one or more first training trajectories.

In some embodiments, the performing the task adaptation comprises: sampling one or more first training trajectories using the meta policy; updating the plurality of first task parameters of the first task policy based on the one or more first training trajectories; sampling one or more second training trajectories using the meta policy; and updating the plurality of second task parameters of the second task policy based on one or more second training trajectories; and the collecting comprises: obtaining the one or more first validation trajectories using the meta policy; and obtaining the one or more second validation trajectories using the meta policy.

In some embodiments, the sampling the one or more first training trajectories using the meta policy comprises: running the meta policy in an environment governed by a Markov Decision Process of the first task, wherein a first training trajectory of the one or more first training trajectories is represented as {s₁, a₁, r₁, . . . , s_{H}, a_{H}, r_{H}}∈D^{train}, D^{train} comprises a plurality of training trajectories, and H is an episode horizon for the first task.

In some embodiments, the updating the meta policy comprises adjusting the plurality of meta parameters, θ, by a gradient expression θ−∇_{θ}{L₁(θ₁; ω₁)+L₂(θ₂; ω₂)}, wherein η is a step size, ∇_{θ} is a gradient operator with respect to the plurality of meta parameters, L₁ and L₂ are a first loss function and a second loss function of the first task and the second task, respectively, θ₁, θ₂∈θ, ω₁ is the first preference vector and ω₂ is the second preference vector.

In some embodiments, the first loss function is of a form L₁(θ₁, ω₁)=−Σ_{{s}_{ₜ}_{,a}_{ₜ}_{π}_{_{θ}}_{}}Σ{ω₁^{T}(\hat{r}(sₜ, aₜ)−V(sₜ))}, where a sum Σ is over t=0 to H₁, \hat{r} is a reward, sₜ is a state in a first MDP at time t, aₜ is an action in the first MDP at the time t, and E is an expectation operator over states and actions defined by the meta policy π_{θ}.

In some embodiments, the one or more first training trajectories correspond to a daily traffic pattern for a low traffic scenario for a first configuration of base stations in a first geographic area.

In some embodiments, the method further comprises initializing the first task parameters randomly.

What is claimed is:

1. A method of obtaining a key performance indicator (KPI) fast-adaptive artificial intelligence (AI) model, the method comprising:
receiving first KPI preference setting information;
obtaining a first AI model based on the first KPI preference setting information;
receiving second KPI preference setting information;
obtaining a second AI model based on the second KPI preference setting information;
obtaining a distilled AI model by knowledge distillation based on the first AI model and the second AI model; and
obtaining the KPI fast-adaptive AI model by meta learning based on the distilled AI model, the first KPI preference setting information and the second KPI preference setting information.

2. The method of claim 1, further comprising applying the KPI fast-adaptive AI model to perform load balancing in a cellular communications system.

3. The method of claim 1, wherein the obtaining the KPI fast-adaptive AI model comprises initializing the KPI fast-adaptive AI model with the distilled policy by first setting parameters of the KPI fast-adaptive AI model to parameters of the distilled policy.

4. The method of claim 3, wherein the obtaining the KPI fast-adaptive AI model by meta learning comprises performing, using the KPI fast-adaptive AI model, task adaptation for a first task associated with a first preference vector and a second task associated with a second preference vector to obtain a plurality of first task parameters and a plurality of second task parameters, wherein the first preference vector indicates a first weighting over a plurality of KPIs and the second preference vector indicates a second weighting over the plurality of KPIs;
collecting one or more first validation trajectories and one or more second validation trajectories, wherein the first task is associated with a first task policy and with first task parameters, and the second task is associated with a second task policy and with second task parameters; and
updating a plurality of meta parameters of the KPI fast-adaptive AI model using the one or more first validation trajectories and the one or more second validation trajectories,
wherein the first and the second tasks are AI models, and the first and the second validation trajectories are histories of the first and the second task policies performing in an environment.

5. The method of claim 1, wherein the obtaining the distilled AI model comprises using a distillation loss function.

6. The method of claim 5, wherein the obtaining the distilled AI model by knowledge distillation based on the first AI model and the second AI model comprises:
training the first AI model, wherein the first AI model corresponds to a first teacher;
training the second AI model, wherein the second AI model corresponds to a second teacher;
collecting a plurality of trajectories using the first teacher and the second teacher; and
training the distilled policy to match state-dependent action probability distributions of the first teacher and the second teacher using the distillation loss function.

7. The method of claim 5, wherein the distillation loss function expresses a Kullback-Leibler (KL) divergence loss.

8. The method of claim 5, wherein the distillation loss function expresses a negative log likelihood loss.

9. The method of claim 5, wherein the distillation loss function expresses a mean-squared error loss.

10. The method of claim 1, further comprising fine tuning the KPI fast-adaptive AI model to approximate a Pareto front.

11. The method of claim 1, wherein the obtaining the KPI fast-adaptive AI model by meta learning comprises:
the performing the task adaptation comprises:
sampling one or more first training trajectories using the KPI fast-adaptive AI model;
updating the plurality of first task parameters of the first task policy based on the one or more first training trajectories;
sampling one or more second training trajectories using the KPI fast-adaptive AI model; and
updating the plurality of second task parameters of the second task policy based on one or more second training trajectories; and
the collecting comprises:
obtaining the one or more first validation trajectories using the KPI fast-adaptive AI model; and
obtaining the one or more second validation trajectories using the KPI fast-adaptive AI model.

12. A server for obtaining a key performance indicator (KPI) fast-adaptive artificial intelligence (AI) model, the server comprising:
one or more processors; and
one or more memories, the one or more memories storing a program, wherein execution of the program by the one or more processors is configured to cause the server to at least:
receive first KPI preference setting information;
obtain a first AI model based on the first KPI preference setting information;
receive second KPI preference setting information;
obtain a second AI model based on the second KPI preference setting information;
obtain a distilled AI model by knowledge distillation based on the first AI model and the second AI model; and
obtain the KPI fast-adaptive AI model by meta learning based on the distilled AI model, the first KPI preference setting information and the second KPI preference setting information.

13. The server of claim 12, wherein execution of the program by the one or more processors is further configured to cause the server to obtain the KPI fast-adaptive AI model by initializing the KPI fast-adaptive AI model with the distilled policy by first setting parameters of the KPI fast-adaptive AI model to parameters of the distilled policy.

14. The server of claim 13, wherein execution of the program by the one or more processors is further configured to cause the server to:
perform, using the KPI fast-adaptive AI model, task adaptation for a first task associated with a first preference vector and a second task associated with a second preference vector to obtain a plurality of first task parameters and a plurality of second task parameters, wherein the first preference vector indicates a first weighting over a plurality of KPIs and the second preference vector indicates a second weighting over the plurality of KPIs;
collect one or more first validation trajectories and one or more second validation trajectories, wherein the first task is associated with a first task policy and with first task parameters, and the second task is associated with a second task policy and with second task parameters; and
update a plurality of meta parameters of the KPI fast-adaptive AI model using the one or more first validation trajectories and the one or more second validation trajectories,
wherein the first and the second tasks are AI models, and the first and the second validation trajectories are histories of the first and the second task policies performing in an environment.

15. The server of claim 12, wherein execution of the program by the one or more processors is further configured to cause the server to obtain the distilled AI model by using a distillation loss function.

16. The server of claim 15, wherein the distillation loss function expresses a Kullback-Leibler (KL) divergence loss.

17. The server of claim 15, wherein the distillation loss function expresses a negative log likelihood loss.

18. The server of claim 15, wherein the distillation loss function expresses a mean-squared error loss.

19. The server of claim 12, wherein execution of the program by the one or more processors is further configured to cause the server to fine tune the KPI fast-adaptive AI model to approximate a Pareto front.

20. A non-transitory computer readable medium configured to store a program for obtaining a key performance indicator (KPI) fast-adaptive artificial intelligence (AI) model, wherein execution of the program by one or more processors of a server is configured to cause the server to at least:
receive first KPI preference setting information;
obtain a first AI model based on the first KPI preference setting information;
receive second KPI preference setting information;
obtain a second AI model based on the second KPI preference setting information;
obtain a distilled AI model by knowledge distillation based on the first AI model and the second AI model; and
obtain the KPI fast-adaptive AI model by meta learning based on the distilled AI model, the first KPI preference setting information and the second KPI preference setting information.
